(19) United States
(12) Patent Application Publication
(10) Pub. No.: US 2008/0007373 A1
(43) Pub. Date: Jan. 10, 2008

(54) Magnet switch with mechanism for preventing impact force imposed thereon

(75) Inventors: Kazuhiro Andoh, Okazaki-shi (JP); Tadahiro Kurasawa, Chita-gun (JP); Yamato Utsunomiya, Kariya-city (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/822,399

(22) Filed: Jul. 5, 2007

(30) Foreign Application Priority Data
Jul. 5, 2006 (JP) 2006-185603

(51) Int. Cl. H01H 75/10

(52) U.S. Cl. 335/38

(57) ABSTRACT

A magnet switch for a starter of the present invention includes a plunger and a switch frame. The plunger has a stepped part at the outer peripheral surface thereof. The switch frame has a projection at an end face thereof, the end face being opposed to the outer peripheral surface of the plunger. Engagement of the stepped part of the plunger with the projection of the switch frame can lock forward movement of the plunger, so that no impact force is imposed on the movable contact and the insulator. Thus, deformation of the movable contact and breakage of the insulator can be prevented, and the axial length of the magnet switch can be reduced to reduce the size of the magnetic switch.

### CROSS-REFERENCE TO RELATED APPLICATION

This application is based on and claims the benefit of priority from earlier Japanese Patent Application No. 2006-185603 filed Jul. 5, 2006, the description of which is incorporated herein by reference.

### BACKGROUND OF THE INVENTION

1. Technical Field of the Invention

The present invention relates to a magnet switch for opening/closing a contact by a magnetic force. In particular, the present invention relates to a reduced-size magnet switch having a mechanism for preventing an impact force imposed on the magnetic switch to prevent damages caused therein, such as deformation of a movable contact or breakage of an insulator.

2. Related Art

A magnet switch for opening/closing a contact by a magnetic force is disclosed, for example, in Japanese Patent Laid-Open No. 3-000969 or a PCT pamphlet of WO00/26533.

The magnetic switch disclosed in Japanese Patent Laid-Open No. 3-000969 includes a plunger, a movable contact attached to a tip end of the plunger, fixed contacts arranged being axially opposed to the movable contact, and a spring that presses the plunger in a direction opposite to the fixed contact. Before being assembled to a starter, the plunger is moved in the direction opposite to the fixed contact by a pressing force of the spring and comes to rest in a state of having the movable contact been in contact with a core. In other words, the movable contact is in contact with the core to lock the movement of the plunger in the direction opposite to the fixed core.

The PCT pamphlet of WO00/26533 discloses a magnet switch including a plunger, a movable contact which is arranged through an insulator at an end of a shaft secured to the plunger, fixed contacts arranged being axially opposed to the movable contact, and a spring that presses the plunger in a direction opposite to the fixed contact. When the magnet switch is excited, the magnetic force allows the plunger to move toward the fixed contact against the pressing force of the spring. When the magnet switch is brought into a non-excited state, the plunger moves in the direction opposite to the fixed contact by the pressing force of the spring and stops with the insulator being in contact with the core. In other words, the insulator comes into contact with the core to lock the movement of the plunger in the direction opposite to the fixed contact.

Each of the magnet switches mentioned above locks the movement of the plunger in the direction opposite to the fixed contact by allowing the movable contact or the insulator to be in contact with the core. Therefore, with the movement of the plunger, a large impact force may be imposed on the movable contact or the insulator. Upon imposition of the impact force, the movable contact may have a risk of being deformed or the insulator may have a risk of being broken. To take measures for this, it has been necessary to increase the thickness of the movable contact or the insulator to ensure sufficient strength. However, the large thickness has necessitated the increase in the axial length of the magnet switch, raising a problem of difficulty in reducing the size of the magnet switch.

### SUMMARY OF THE INVENTION

The present invention has been made in light of the problem described above, and has as its object to provide a magnetic switch, which can prevent deformation of a movable contact or breakage of an insulator, while reducing the axial length of the magnetic switch to reduce the size of the magnetic switch.

The inventors of the present invention have conceived an idea of preventing the deformation of the movable contact or the breakage of the insulator by forming a projection at a core or a bobbin and providing the plunger with a stepped part that engages with the projection to make the present invention.

The present invention provides, as one aspect thereof, a magnet switch comprising: a bobbin formed into a cylindrical shape with a cylindrical bore formed therein, the cylindrical shape providing a central axis parallel with an axial direction of the bore, a circumferential direction defined as a direction around the central axis, and a radial direction defined as directions extending radially from the central axis; a coil wound around the bobbin and formed to generate magnetic flux in response to current to be supplied to the coil; a first core formed into a plate having a through hole and fixedly disposed on one side of the bobbin in the axial direction, the magnetic flux passing the first core; a second core formed into a bottomed cylinder having an bottom through which a through hole is formed and disposed to enclose the bobbin and the first core, the bottom being located on the other side of the bobbin in the axial direction and opposed to the first core, the magnetic flux passing second core; a plunger formed into a columnar shape and disposed in the bore of the bore of the bobbin so as to be slidable in the axial direction, the magnetic flux passing second core; a spring disposed between the plunger and the first core to push the plunger toward the bottom of the second core; a rod attached to the plunger so that the rod extends through the through hole of the first core in the axial direction; a movable electric contact electric-insulatedly attached to an end of the rod extended from the first core; and fixed electric contacts disposed to be apart from and face the movable electric contact in the axial direction. Either the through hole of the bottom of the second fore or an inner circumferential surface partitioning the bore of the bobbin is formed to, at least partly in the circumferential direction, have a projected portion projecting than an inner circumferential surface partitioning the bore in the radial direction. The plunger has an outer circumferential surface having a stepped portion to be engageable with the projected portion so that the plunger is prohibited from moving any more away from the first core in the axial direction, the stepped portion being located in the axial direction so as to positionally regulate the plunger in the axial direction such that the plunger is allowed to locate when no current is supplied to the coil.

It is preferred that the through hole of the bottom of the second core is formed to have the projected portion.

The configuration described above may prevent deformation of the movable contact or breakage of the insulator, while reducing the axial length of the magnetic switch to reduce the size of the magnet switch. The second core has the projection provided at the inner peripheral surface of the through hole, the inner peripheral surface facing the outer peripheral surface of the plunger. The plunger is provided, on its outer peripheral surface, with a stepped part to be in engagement with the projection at the second core. Thus, the engagement of the stepped part of the plunger with the projection of the second core may lock the movement of the plunger toward the second core, whereby, unlike the conventional magnet switch, no impact force is imposed on the movable contact or the insulator. Thus, the movable contact may be prevented from being deformed and the insulator may be prevented from being broken. Also, such a configuration of the magnet switch has no need of thickening the movable contact or the insulator to ensure its strength, whereby the axial length of the magnetic switch can be shortened to reduce the size of the magnetic switch.

It is also preferred that wherein the inner circumferential surface partitioning the bore of the bobbin is formed to have the projected portion.

The configuration described above can prevent deformation of the movable contact or breakage of the insulator, while reducing axial length of the magnet switch to reduce the size of the magnetic switch. The bobbin has a projection at its inner peripheral surface and the plunger has a stepped part at its outer peripheral surface to be engaged with the projection of the bobbin. Thus, the engagement of the stepped part of the plunger with the projection of the bobbin may lock the movement of the plunger toward the second core, whereby, unlike the conventional magnet switch, no impact force is imposed on the movable contact or the insulator. Thus, the movable contact may be prevented from being deformed and the insulator may be prevented from being broken. Also, such a configuration of the magnet switch has no need of thickening the movable contact or the insulator to ensure its strength, whereby the axial length of the magnetic switch can be shortened to reduce the size of the magnetic switch.

It is preferred that the movable electric contact is positioned to have a preset clearance from the first core when the plunger is prohibited from moving any more away from the first core in the axial direction.

According to the configuration described above, the impact force imposed on the movable contact or the insulator can be reliably mitigated.

It is still preferred that the plunger has a first columnar part and a second columnar part fixedly and coaxially attached to the first columnar part on a side of the first columnar part in the axial direction and formed to be smaller in diameter than the first columnar part, which side faces the bottom, and the stepped portion is located between the first and second columnar parts and formed to have an annular shape.

The above configuration can ensure formation of the stepped part at the plunger.

It is still preferred that a clearance formed between an outer circumferential surface of the second columnar part and the inner circumferential surface of the bobbin is larger than a clearance formed between outer circumferential surface of the second columnar part and the projected portion.

The configuration described above may prevent suction of water to the side of the first columnar part of the plunger. The clearance between the outer peripheral surface of the second columnar part and the inner peripheral surface of the bobbin is larger than the clearance between the outer peripheral surface of the second columnar part and the end face of the projection. Accordingly, movement of the plunger toward the first core may ensure formation of a space on the side of the second core of the first columnar part, the space being larger than the space defined by the second columnar part and the projection. In this way, in case of the possible attachment of water droplets to the outer peripheral surface of the second columnar part by, for example, being submerged in water, air contained in this large space can prevent suction of water to the side of the first columnar part of the plunger.

### BRIEF DESCRIPTION OF THE DRAWINGS

In the accompanying drawings:

FIG. 1 is a cross sectional view of a magnet switch for a starter, according to a first embodiment of the present invention;

FIG. 2 is an enlarged cross sectional view in the vicinity of a stepped part of a plunger and a projection of a switch frame, according to the first embodiment;

FIG. 3 is a cross sectional view of a magnet switch for a starter, according to a second embodiment of the present invention; and

FIG. 4 is an enlarged cross sectional view in the vicinity of a stepped part of a plunger and a projection of a bobbin, according to the second embodiment.

### DETAILED DESCRIPTION OF THE PREFERRED EMBODIMENTS

Hereinafter are described in detail some embodiments of the present invention with reference to the accompanying drawings. In each of these embodiments, which are provided just as examples, the present invention is applied to a magnet switch for a starter (hereinafter referred to as a “starter magnet switch”), which supplies electrical power to a starter motor and drives a lever for driving a pinion.

### First Embodiment

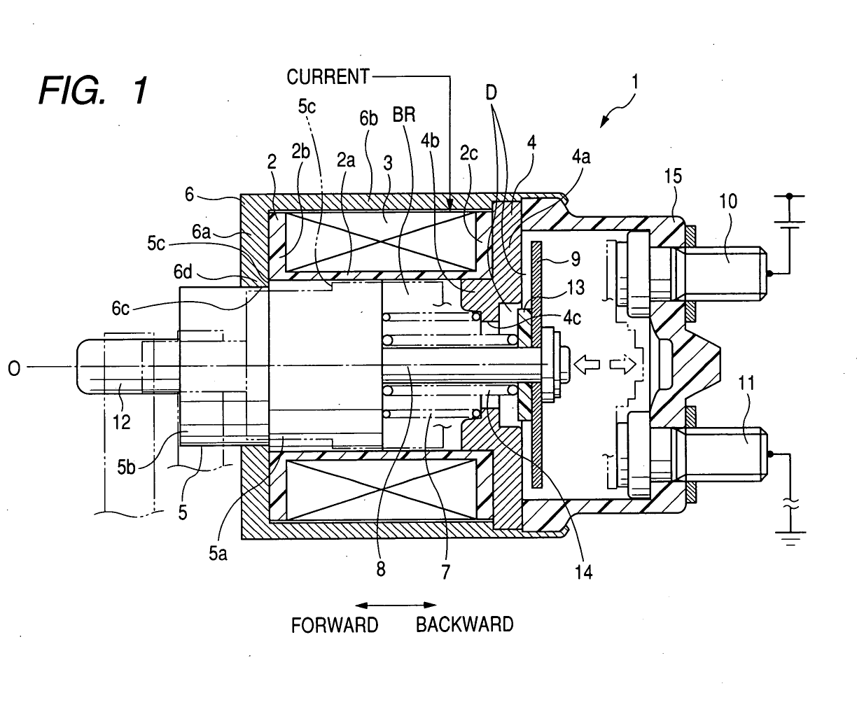

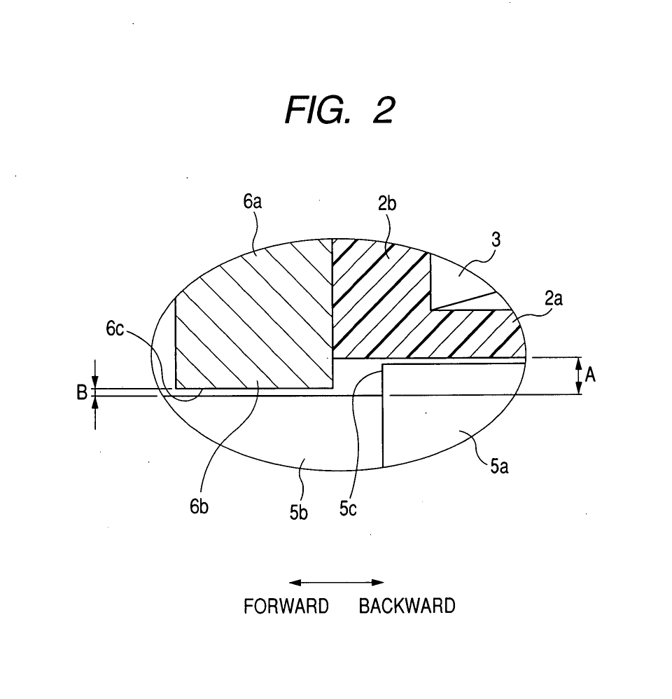

Referring to FIGS. 1 and 2, an explanation will be focused on a configuration of a starter magnet switch. FIG. 1 is a cross sectional view of a starter magnet switch, according to a first embodiment of the present invention. FIG. 2 is an enlarged cross sectional view in the vicinity of a stepped part of a plunger and a projection of a switch frame, according to the first embodiment.

As shown in FIG. 1, a starter magnet switch 1 (composing a magnet switch) includes a bobbin 2, an excitation coil 3 (coil), a stationary core 4 (composing a first core), a plunger 5, a switch frame 6 (composing a second core), a return spring 7 (composing a spring), a rod 8, a movable contact 9, and fixed contacts 10 and 11.

The bobbin 2, which holds the excitation coil 3, is a cylindrical member made of resin to provide insulation from other members. The bobbin 2 consists of a cylindrical part 2a and flange parts 2b and 2c formed at both end portions of the cylindrical part 2a. As shown in FIG. 1, the bobbin 2 has a cylindrical bore BR in which the plunger 5 and the rod 8 are inserted movably along the direction of a central axis “O” of the bore BR. In the present embodiment, an axial direction is defined as a direction parallel with the central axis, a circumferential direction is defined as a direction around the central axis, and a radial direction is defined as directions extending radially from the central axis.

The excitation coil 3 is a winding which produces magnetic force for attracting the plunger 5 with the supply of current. The excitation coil 3 is wound about an outer periphery of the cylindrical part 2a of the bobbin 2.

The stationary core 4 is a disc-like member made of a magnetic material that forms a portion of a magnetic path. The stationary core 4 consists of a disc-like bottom part 4a and a columnar part 4b which is formed at the center portion of the bottom part 4a in the axial direction. The center portion of the stationary core 4 is provided with a through hole 4c in the axial direction.

The stationary core 4 is arranged at a rear end portion of the excitation coil 3 in such a way that the outer peripheral surface of the cylindrical part 4b is in contact with the inner peripheral surface of the columnar part 2a of the bobbin 2, and that an end face on the side of the bottom part 4a is in contact with the flange part 2c.

The plunger 5 is a cylindrical member made of a magnetic material, forming a portion of the magnetic path and providing a reciprocal movement by the magnetic force which is produced by the excitation coil 3 to drive the lever for moving a pinion and the movable contact 9. The plunger 5 is made up of a large-diameter columnar part 5a (composing a first columnar part), whose outer diameter is slightly smaller than the inner diameter of the cylindrical part 2a of the bobbin 2, and a small-diameter columnar part 5b (composing a second columnar part), which is formed at one end of the large-diameter columnar part 5a so as to be coaxial therewith, and whose outer diameter is smaller than that of the large-diameter columnar part 5a.

An annular stepped part 5c is formed at a linkage portion between the large-diameter columnar part 5a and the small-diameter columnar part 5b. The plunger 5 is arranged inside the bobbin 2 so as to be reciprocally movable in the axial direction, with an end face thereof on the side opposite to the small-diameter columnar part 5b being opposed to the stationary core 4. A rod 12 for driving the lever for moving a pinion is arranged at an end face of the small-diameter columnar part 5b.

The switch frame 6 is a bottomed cylindrical member made of a magnetic material and forming a portion of the magnetic path. The switch frame 6 is structured by a disc-like bottom part 6a and a cylindrical part 6b formed axially extending from an outer peripheral end portion of the bottom part 6a. A through hole 6c is axially formed at a center portion of the bottom part 6a so as to have an inner diameter smaller than that of the cylindrical part 2a of the bobbin 2 and slightly larger than the outer diameter of the small-diameter columnar part 5b of the plunger 5.

Thus, an annular projection 6d is formed, projecting toward an axial center from the inner peripheral surface of the cylindrical part 2a of the bobbin 2. That is, the annular projection 6d can be regarded as being formed at the inner peripheral surface of a through hole (not shown) whose inner diameter is the same as that of the cylindrical part 2a of the bobbin 2, so as to project from the inner peripheral surface of the cylindrical part 2a of the bobbin 2 toward the axial center in the radial direction.

Incidentally, it is not always necessary that the projection 6d is formed in the annular shape when viewed along the axial direction. The projection 6d may be formed partly in the circumferential direction.

The switch frame 6 is arranged surrounding the excitation coil 3, with the small-diameter part 5b of the plunger 5 being inserted into the through hole 6c to have the inner peripheral surface of the through hole 6c faced the outer peripheral surface of the small-diameter columnar part 5b, and with the inner peripheral surface of an end portion of the cylindrical part 6b being in contact with the outer peripheral surface of the bottom part 4a of the stationary core 4.

In this case, as shown in FIG. 2, a clearance “A” is defined between the outer peripheral surface of the small-diameter columnar part 5b of the plunger 5 and the inner peripheral surface of the cylindrical part 2a of the bobbin 2. Also, a clearance “B” is defined between the outer peripheral surface of the small-diameter columnar part 5b and an end face opposed thereto of the projection 6d of the bobbin 2, i.e. the inner peripheral surface of the through hole 6c. The clearance A is larger than the clearance B.

The return spring 7 is a member that presses the plunger 5 in a direction opposite to stationary core 4. The return spring 7 is arranged between the stationary core 4 and the plunger 5, with one end thereof being in contact with the columnar part 4b of the stationary core 4, and with the other end being in contact with an end face of the large-diameter part 5a of the plunger 5, the end face being on the side opposite to the small-diameter columnar part 5b.

The rod 8 is a columnar member securing the movable contact to the plunger 5. The rod 8 is secured to an end face of the large-diameter columnar part 5a of the plunger 5, the end face being on the side opposite to the small-diameter columnar part 5b, so that an end portion of the rod 8 is projected toward the side opposite to the plunger 5 through the through hole 4c of the stationary core 4.

The movable contact 9 is a plate-like member made of metal, which provides reciprocal movement in integration with the plunger 5 through the rod 8 so as to connect or disconnect between the fixed contacts 10 and 11. The movable contact is arranged at a tip end portion of the rod 8 through an insulator 13. Thus, it is so arranged that when the stepped part 5c of the plunger 5 comes into engagement with the projection 6d of the switch frame 6 to lock the movement of the plunger 5, a predetermined clearance is ensured to be made between the movable contact 9 and the insulator 13, and the bottom part 4a of the stationary core 4. The movable contact 9 is pressed against the fixed contacts 10 and 11 together with the insulator 13 by a contact-pressure spring 14.

The fixed contacts 10 and 11 are bolt-like members made of metal, which are connected to each other via the movable contact 9 to supply DC voltage of a battery (not shown) to a starter motor. The fixed contacts 10 and 11 are fixed to a bottom portion of a bottomed cylindrical contact cover 15 made of resin surrounding the movable contact 9, so that each of the fixed contacts may axially face the movable contact 9.

Referring now to FIG. 1, the operation of the starter magnet switch is described below. Before current is supplied to the excitation coil 3, the plunger 5 is pressed forward by the return spring 7 and locked, with the stepped part 5c being engaged with the projection 6d of the switch frame 6. In this case, the movable contact 9 and the insulator 13 stand without contacting the stationary core 4, or being drawn apart from the stationary core 4 by the predetermined clearance.

Upon switching on of an ignition switch (not shown), current is supplied to the excitation coil 3, which then produces magnetic force. The produced magnetic force allows the plunger 5 to be attracted to the stationary core 4, while pressing the return spring 7. The attraction of the plunger 5 then allows the rod 12 to drive the lever for moving a pinion, so that the pinion can be engaged with a ring gear of an engine. Meanwhile, the movable contact 9 comes into contact with the fixed contacts 10 and 11 (refer to a state shown by chain double-dashed lines in FIG. 1). Upon contact of the movable contact 9 with the fixed contacts 10 and 11, DC voltage of the battery is supplied to the starter motor to start the engine.

When the engine is started and the ignition switch is turned off, current supply to the excitation coil 3 is interrupted. Thus, the magnetic force of the excitation coil 3 is eliminated, whereby the plunger 5 is pressed back forward by the return spring 7. When the plunger 5 is pressed back, the rod 12 is also pressed back to release the pinion of the starter motor from the engine-side gear. Also, the movable contact 9 is drawn apart from the fixed contacts 10 and 11. With the movable contact 9 being drawn apart from the fixed contacts 10 and 11, supply of the DC current from the battery is interrupted to stop the starter motor. After that, the plunger is locked with the stepped part 5c being engaged with the projection 6d of the switch frame 6 (refer to a state shown by solid lines in FIG. 1). The movable contact 9 and the insulator 13 stop without contacting the stationary core 4, or stop being drawn apart from the stationary core 4 by the predetermined clearance “D” (refer to FIG. 1).

Finally, advantages of the first embodiment will be explained. According to the first embodiment, deformation of the movable contact 9 and breakage of the insulator 13 can be prevented. At the same time, the axial length of the starter magnet switch 1 can be reduced to reduce the size of the magnetic switch. The switch frame 6 has the projection 6d at the through hole 6c, which faces the outer peripheral surface of the plunger 5.

Also, the plunger 5 is provided, at its outer peripheral surface, with the stepped part 5c to be engaged with the switch frame 6. Accordingly, the engagement of the stepped part 5c of the plunger 5 with the projection 6d of the switch frame 6 can lock the forward movement of the plunger 5. Thus, unlike the conventional magnet switches, no impact force is imposed on the movable contact 9 and the insulator 13, so that deformation of the movable contact 9 and breakage of the insulator 13 can be prevented.

In addition, the movable contact 9 and the insulator 13 need not be thickened to ensure the strength, whereby the axial length of the starter magnet switch 1 can be reduced to reduce the size of the magnetic switch.

According to the first embodiment, when the plunger 5 is locked, the predetermined clearance can be ensured between the movable contact 9 and the insulator 13, and the stationary core 4. Therefore, the impact force imposed on the movable contact 9 and the insulator 13 can be reliably suppressed.

According to the first embodiment, the plunger 5 is made up of the large-diameter columnar part 5a and the small-diameter columnar part 5b to ensure formation of the stepped part 5c at the linkage portion.

Additionally, according to the first embodiment, water can be prevented from being sucked to the side of the large-diameter columnar part 5a of the plunger 5. As shown in FIG. 2, the clearance “A” formed between the outer peripheral surface of the small-diameter columnar part 5b and the inner peripheral surface of the cylindrical part 2a of the bobbin 2 is larger than the clearance “B” formed between the outer peripheral surface of the small-diameter columnar part 5b and the inner peripheral surface of the projection 6d of the switch frame 6. Therefore, when the plunger 5 is moved backward, a space can be formed at the front of the large-diameter columnar part 5b, the space being larger than the space defined between the small-diameter columnar part 5b and the projection 6d. Thus, in case of the possible attachment of water droplets to the outer peripheral surface of the small-diameter columnar part 5b by, for example, being submerged in water, air contained in this large space can prevent suction of water to the side of the large-diameter columnar part 5a.

### Second Embodiment

Hereinafter is described a starter magnet switch according to a second embodiment of the present invention. In the present embodiment, the identical or similar components to those in the first embodiment are given the same reference numerals for the sake of simplifying or omitting the explanation.

The starter magnet switch of the second embodiment is different from that of the first embodiment in that the projection formed at the switch frame in the first embodiment is formed at the bobbin.

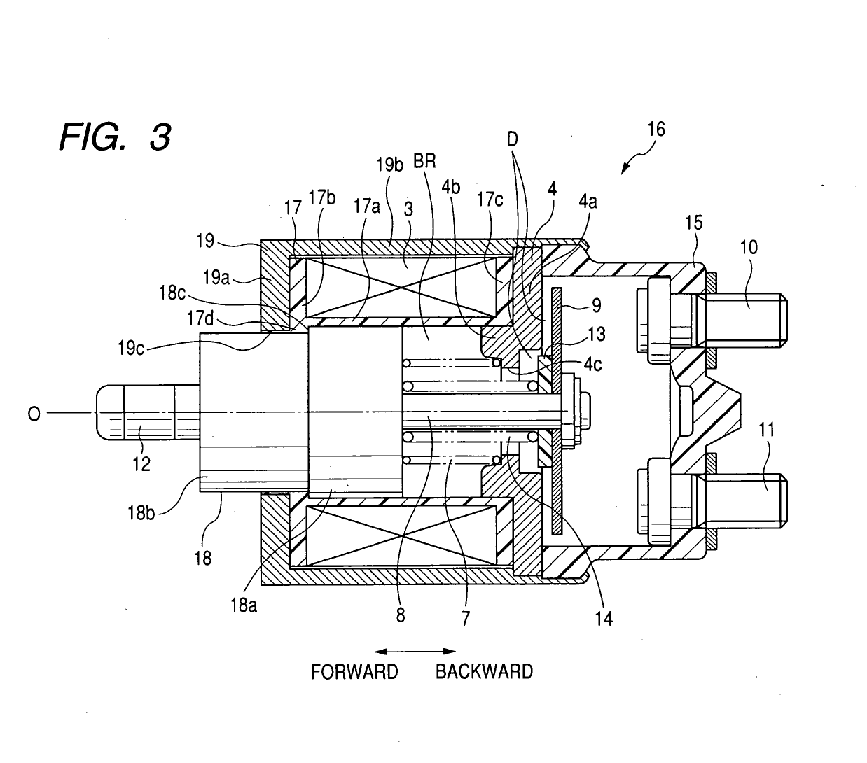

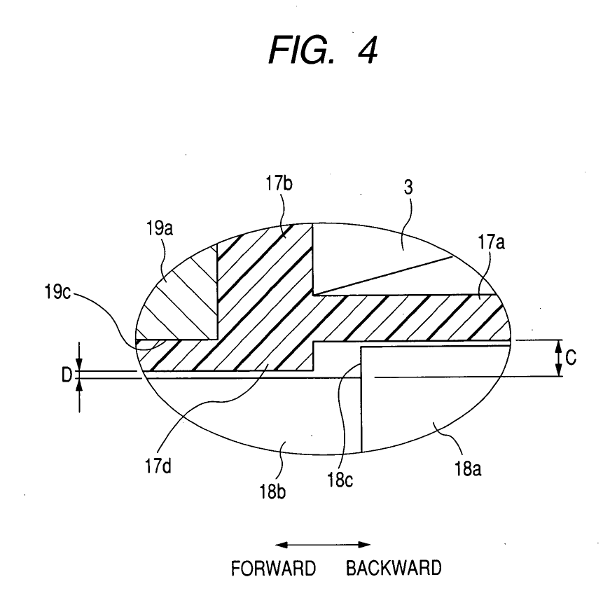

With reference to FIGS. 3 and 4, a configuration of the starter magnet switch of the second embodiment will be described. FIG. 3 is a cross sectional view of the starter magnet switch according to the second embodiment. FIG. 4 is an enlarged cross sectional view in the vicinity of a stepped part of the plunger and a projection of the bobbin. Description here is focused only on the structures of the bobbin, the plunger and the switch frame, which make differences from the starter magnet switch of the first embodiment, and description on the portions common to the two embodiments is omitted except for the portions that require explanation.

As shown in FIG. 3, a starter magnet switch 16 includes a bobbin 17, the excitation coil 3, the stationary core 4, a plunger 18, a switch frame 19, the return spring 7, the rod 8, the movable contact 9, and the fixed contacts 10 and 11.

The bobbin 17 is made up of a cylindrical part 17a, flange parts 17b and 17c formed at both end portions of the cylindrical part 17a, and an annular projection 17d formed at the inner peripheral surface of the flange part 17b, being projected toward the axial center.

The plunger 18 is made up of a large-diameter columnar part 18a (composing a first columnar part) whose outer diameter is slightly smaller than the inner diameter of the cylindrical part 17a of the bobbin 17, and a small-diameter columnar part 18b (composing a second columnar part) which is formed at an end of the large-diameter columnar part 18a so as to be coaxial therewith, and whose outer diameter is slightly smaller than the inner diameter of the projection 17d. An annular stepped part 18c is formed at a linkage portion between the large-diameter columnar part 18a and the small-diameter columnar part 18b.

The switch frame 19 is structured by a disc-like bottom part 19a, and a cylindrical part 19b axially extending from an outer peripheral end portion of the bottom part 19a. A through hole 19c having an inner diameter substantially equal to that of the cylindrical part 17a is axially formed at a center portion of the bottom part 19a.

As shown in FIG. 4, a clearance C is defined between the outer peripheral surface of the small-diameter columnar part 18b of the plunger 18 and the inner peripheral surface of the cylindrical part 17a of the bobbin 17. Also, a clearance D is defined between the outer peripheral surface of the small-diameter columnar part 18b and the inner peripheral surface opposed thereto of the projection 17d of the bobbin 17. The clearance C is larger than the clearance D. As shown in FIG. 3, the plunger 18 is locked being pressed forward by the return spring 7 and with the stepped part 18c being in engagement with the projection 17d of the bobbin 17.

The operation of the starter magnet switch of the present embodiment is omitted, for it is the same as the operation of the starter magnet switch of the first embodiment.

Finally, advantages of the second embodiment will be explained. According to the second embodiment, deformation of the movable contact 9 and breakage of the insulator 13 can be prevented. At the same time, the axial length of the starter magnet switch 16 can be reduced to reduce the size of the magnetic switch. The bobbin 17 has the projection 17d at the inner peripheral surface. Also, the plunger 18 is provided, at its outer peripheral surface, with the stepped part 18c to be engaged with the projection 17d of the bobbin 17.

Accordingly, the engagement of the stepped part 18c of the plunger 18 with the projection 17d of the bobbin 17 can lock the forward movement of the plunger 18. Thus, unlike the conventional magnet switches, no impact force is imposed on the movable contact 9 and the insulator 13, so that deformation of the movable contact 9 and breakage of the insulator 13 can be prevented. In addition, the movable contact 9 and the insulator 13 need not be thickened to ensure the strength, whereby the axial length of the starter magnet switch 16 can be reduced to reduce the size of the magnetic switch.

Additionally, according to the second embodiment, water can be prevented from being sucked to the side of the large-diameter columnar part 18a of the plunger 18. As shown in FIG. 4, the clearance between the outer peripheral surface of the small-diameter columnar part 18b and the inner peripheral surface of the cylindrical part 17a of the bobbin 17 is larger than the clearance between the outer peripheral surface of the small-diameter columnar part 18b and the inner peripheral surface of the projection 17d of the bobbin 17.

Therefore, when the plunger 18 is moved backward, a space can be formed at the front of the large-diameter columnar part 18b, the space being larger than the space defined between the small-diameter columnar part 18b and the projection 17d. Thus, in case of the possible attachment of water droplets to the outer peripheral surface of the small-diameter columnar part 18b by, for example, being submerged in water, air contained in this large space can prevent suction of water to the side of the large-diameter columnar part 18a.

The first and second embodiments have exemplified magnet switches using the cylindrical bobbins 2 and 17, and the columnar plungers 6 and 18, respectively. However, the shapes of these components are not limited to those in the first and second embodiments. For example, the bobbin may have an elliptic cylindrical shape or a polygonal cylindrical shape. Accordingly, the plunger may have an elliptic columnar shape or a polygonal columnar shape.

Further, the first and second embodiments have exemplified magnet switches having the projections 6d and 17d, and the annular stepped parts 5c and 18c, respectively. However, the shapes of these components are not limited to those in the first and second embodiments. For example, a circular projection or a stepped part may be arranged in plural number.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A magnet switch comprising:
a bobbin formed into a cylindrical shape with a cylindrical bore formed therein, the cylindrical shape providing a central axis parallel with an axial direction of the bore, a circumferential direction defined as a direction around the central axis, and a radial direction defined as directions extending radially from the central axis;
a coil wound around the bobbin and formed to generate magnetic flux in response to current to be supplied to the coil;
a first core formed into a plate having a through hole and fixedly disposed on one side of the bobbin in the axial direction, the magnetic flux passing the first core;
a second core formed into a bottomed cylinder having an bottom through which a through hole is formed and disposed to enclose the bobbin and the first core, the bottom being located on the other side of the bobbin in the axial direction and opposed to the first core, the magnetic flux passing second core;
a plunger formed into a columnar shape and disposed in the bore of the bore of the bobbin so as to be slidable in the axial direction, the magnetic flux passing second core;
a spring disposed between the plunger and the first core to push the plunger toward the bottom of the second core;
a rod attached to the plunger so that the rod extends through the through hole of the first core in the axial direction;
a movable electric contact electric-insulatedly attached to an end of the rod extended from the first core; and
fixed electric contacts disposed to be apart from and face the movable electric contact in the axial direction,
wherein either the through hole of the bottom of the second fore or an inner circumferential surface partitioning the bore of the bobbin is formed to, at least partly in the circumferential direction, have a projected portion projecting than an inner circumferential surface partitioning the bore in the radial direction, and
wherein the plunger has an outer circumferential surface having a stepped portion to be engageable with the projected portion so that the plunger is prohibited from moving any more away from the first core in the axial direction, the stepped portion being located in the axial direction so as to positionally regulate the plunger in the axial direction such that the plunger is allowed to locate when no current is supplied to the coil.

2. The magnet switch of claim 1, wherein the through hole of the bottom of the second core is formed to have the projected portion.

3. The magnet switch of claim 2, wherein the through hole of the bottom of the second core has a diameter smaller than a diameter of the bore of the bobbin such that the projected portion is formed in the circumferential direction.

4. The magnet switch of claim 3, wherein the movable electric contact is positioned to have a preset clearance from the first core when the plunger is prohibited from moving any more away from the first core in the axial direction.

5. The magnet switch of claim 4, wherein the plunger has a first columnar part and a second columnar part fixedly and coaxially attached to the first columnar part on a side of the first columnar part in the axial direction and formed to be smaller in diameter than the first columnar part, which side faces the bottom, and the stepped portion is located between the first and second columnar part s and formed to have an annular shape.

6. The magnet switch of claim 5, wherein a clearance formed between an outer circumferential surface of the second columnar part and the inner circumferential surface of the bobbin is larger than a clearance formed between outer circumferential surface of the second columnar part and the projected portion.

7. The magnet switch of claim 1, wherein the movable electric contact is positioned to have a preset clearance from the first core when the plunger is prohibited from moving any more away from the first core in the axial direction.

8. The magnet switch of claim 1, wherein the plunger has a first columnar part and a second columnar part fixedly and coaxially attached to the first columnar part on a side of the first columnar part in the axial direction and formed to be smaller in diameter than the first columnar part, which side faces the bottom, and the stepped portion is located between the first and second columnar parts and formed to have an annular shape.

9. The magnet switch of claim 8, wherein a clearance formed between an outer circumferential surface of the second columnar part and the inner circumferential surface of the bobbin is larger than a clearance formed between outer circumferential surface of the second columnar part and the projected portion.

10. The magnet switch of claim 1, wherein the inner circumferential surface partitioning the bore of the bobbin is formed to have the projected portion.

11. The magnet switch of claim 10, wherein the movable electric contact is positioned to have a preset clearance from the first core when the plunger is prohibited from moving any more away from the first core in the axial direction.

12. The magnet switch of claim 11, wherein the plunger has a first columnar part and a second columnar part fixedly and coaxially attached to the first columnar part on a side of the first columnar part in the axial direction and formed to be smaller in diameter than the first columnar part, which side faces the bottom, and the stepped portion is located between the first and second columnar parts and formed to have an annular shape.

13. The magnet switch of claim 12, wherein a clearance formed between an outer circumferential surface of the second columnar part and the inner circumferential surface of the bobbin is larger than a clearance formed between outer circumferential surface of the second columnar part and the projected portion.
